(19) United States
(12) Patent Application Publication
(10) Pub. No.: US 2003/0204526 A1
(43) Pub. Date: Oct. 30, 2003

(54) Interlocking smart fob enabling secure access and tracking for electronic devices

(76) Inventor: Saeid Salehi-Had, Palo Alto, CA (US)

Correspondence Address: Saeid Salehi-Had, 3810 Whitsell St., Palo Alto, CA, 94306, US

(21) Appl. No.: 10/128,362

(22) Filed: Apr. 24, 2002

(51) Int. Cl. G06F 7/00

(52) U.S. Cl. 707/104.1

(57) ABSTRACT

The device in question is a wearable fob with an interlocking clasp, able to send, receive and store data, which once activated by the users initial manual login, allows the user access an electronic device, or any other electronic device on a server system, so long as the clasping fob is not unclasped, without requiring another manual login. Unclasping the device causes the user information to be erased and the device reset. An activated clasping fob, when brought into close proximity with a compatible electronic device, will communicate user authentication and other information to the electronic device, logging that user into that electronic device. When the fob is removed from the proximity of the electronic device, the user is automatically logged out. This allows the user to access that electronic device, or a network of electronic devices, as long as the clasping fob is worn, without manually logging in and out, meanwhile keeping a record of user activity on the network.

### BACKGROUND

1. Field of Invention

This invention relates to the access and security of electronic devices.

2. Prior Art

Access and security of electronics has been a concern since the invention of computers. The traditional ‘manual log-in’ is still used extensively and works fine for applications that do not require repeated logging in, the loss of efficiency is minimal.

In an effort to improve efficiency, access and security has been controlled for some time now by smart cards and fobs, which either interact wirelessly with a electronic device when the card or fob is brought into close proximity to the device, or require the card to be swiped or inserted into a slot. U.S. Pat. No. 6,199,114 to WebTV Networks, Inc. (1999) and WO 01/40929 to Ensure Technologies, Inc. (2000) are examples of this kind of device. While these devices do make network access more efficient, their shortcoming is that they provide no real security because a smart card or fob found or stolen by someone gives them all the access and privileges of the authorized user. Another shortcoming of U.S. Pat. No. 6,199,114 is that the act of swiping or inserting a smart card into a slot on a smart card reader is another inefficiency.

U.S. Pat. No. 5,983,273 improves on the security of system in some ways because the user of the smart card is also required to give a password, but this again creates efficiency issues. In another claim of U.S. Pat. No. 5,983,273 the password is only required at the initial log-on, which helps the efficiency, but again raises a security issue if the card is lost or stolen.

Objects and Advantages

Accordingly, several objects and advantages of the present invention are:

The smart fob has an interlocking clasp, and is worn by a person. Removal from the person necessitates unclasping, which triggers the interlock, which resets the fob memory.

After initial clasping once the fob is in close proximity to the electronic device the user is prompted for authentication and or authorization information which is then stored on the clasped device and is used from then on every time in close proximity to the electronic device obviating the need for repeated manual entry of authentication and or authorization information for as long as the fob remains clasped.

A found or stolen fob will never give an unauthorized user access to an electronic device because for a fob to be found or stolen, it must have been unclasped, and therefore reset.

This is particularly useful for electronic devices that are used by multiple users, as each user can come and go many times and have seamless access to the electronic device.

The fob does not belong to an individual, after it is unclasped from one person it can be easily reused by another.

### DRAWING FIGURES

FIG. 1 shows a smart fob with an interlocking clasp.

FIG. 2 shows a person wearing a smart fob with an interlocking clasp accessing a computer.

FIG. 3 shows a person wearing a smart fob with an interlocking clasp accessing a telephone.

FIG. 4 shows the method of using a smart fob with an interlocking clasp to access an electronic device.

### REFERENCE NUMERALS IN DRAWINGS

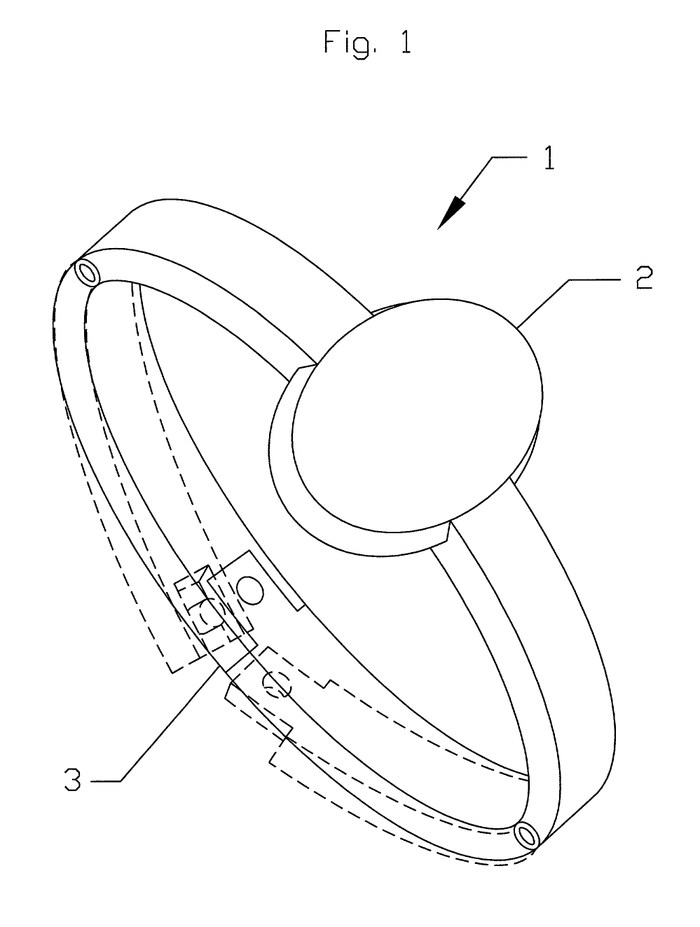

FIG. 1:

(1) Fob with interlocking clasp

(2) Electronic fob

(3) Interlocking clasp

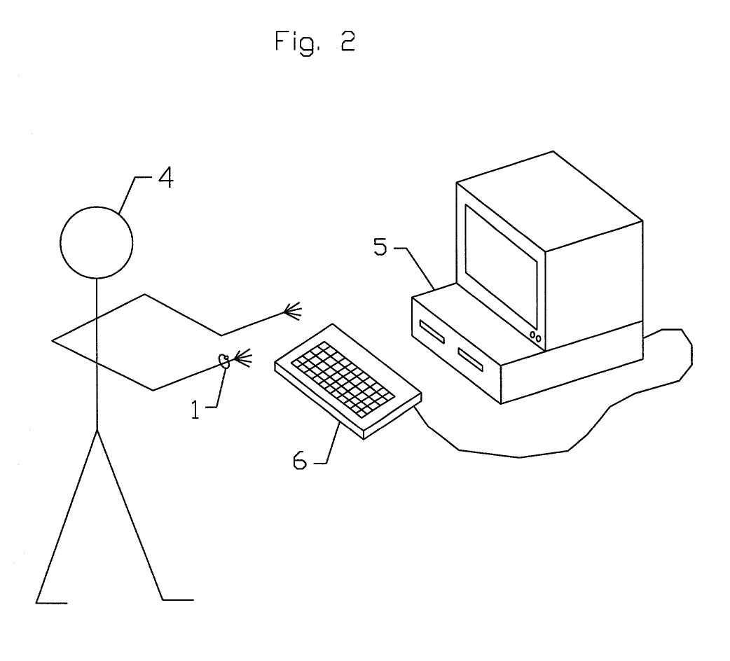

FIG. 2:

(4) Person

(1) Fob with interlocking clasp

(5) Computer

(6) Keyboard

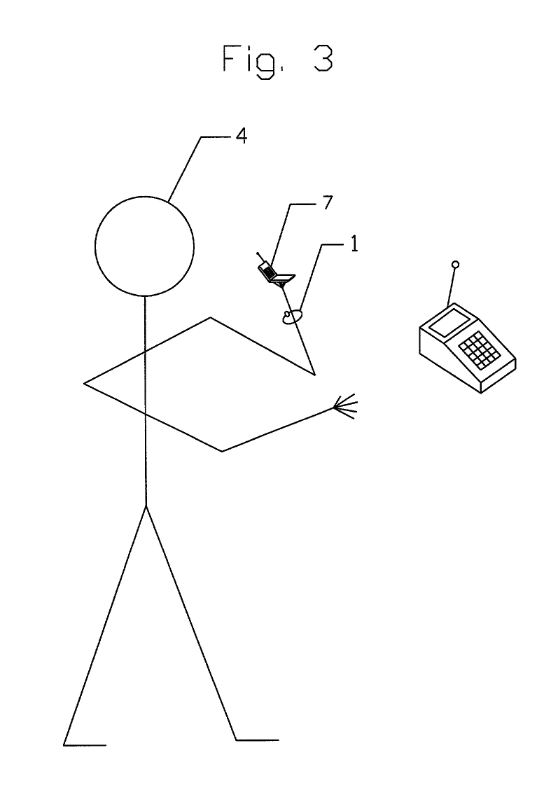

FIG. 3:

(4) Person

(1) Fob with interlocking clasp

(7) Wireless telephone

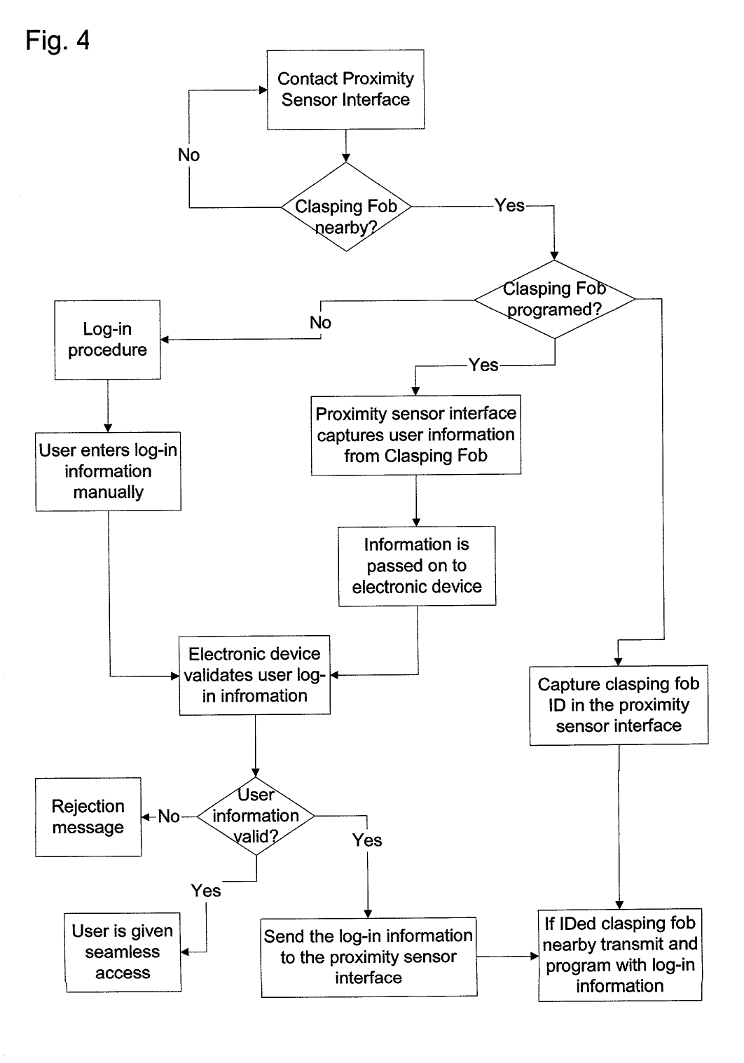

FIG. 4:

Method Flowchart

### SUMMARY

The invention is for a device, a system and a method; the device is a clasping fob with an interlock, the system that incorporates the fob plus a data entry device that passes either wirelessly entered or manually entered data to an electronic device, and a method of using the devices to access the electronic device.

Description

Example embodiment of the invention is illustrated in FIGS. 1-4. FIG. 1 shows the clasping fob with the electronic fob (2) and the interlocking clasp (3). In FIG. 2, a user (4) wearing a clasping fob (1) accesses a computer terminal (5) through a keyboard (6). In FIG. 3, a user (4) wearing a clasping fob (1) gains access to a mobile telephone (7). FIG. 4 shows the flowchart that details the method by which the user gains access to electronic devices using the clasping fob. When user initially attaches the clasping fob around their self the fob is activated but the erasable memory is blank. When the user approaches an electronic device for the first time since clasping the fob, the user is prompted for manual log-in. Thereafter, when the user approaches any electronic device on that system, manual log-in is not required. The user is automatically logged in, so long as they have not unclasped the fob. After unclasping the fob, the memory is again reset and ready for a new user.

Operation

The manner of using the clasping fob to access an electronic device is as follows:

Initially, the fob is unclasped and the memory blank. The user will clasp on the fob (i.e. around the wrist), and the fob is now activated but the memory is still blank.

When the user approaches an electronic device which has a means of verifying that the clasping fob is a valid device, the electronic device detects the presence of the fob and also detects that it is still blank. The electronic device therefore asks the user for a manual log-in. The manual login is verified with the previously stored user authentication information (i.e. password). When the user has been authenticated, the electronic device allows the user access and also sends the authentication information to the fob, where it is stored in memory.

The electronic device detects the proximity of the clasping fob on a periodic base and when the user leaves the proximity of the electronic device, it no longer senses the proximity of the fob and the user is automatically logged out.

When the user now approaches that or another electronic device coupled to the same server system, the electronic device detects the presence of the clasping fob, detects that the fob has authentication information, receives the authentication information, verifies the authentication information and the user is automatically logged onto the electronic device. This process is fast enough that it is invisible to the user. Leaving the proximity of the electronic device is again detected and causes the user to be automatically logged off the electronic device.

When the user unclasps the fob (i.e. at the end of a work shift), the fob is reset and all user information in the memory is erased, making it unusable until a user repeats the above process from the beginning.

Conclusions, Ramifications and Scope

Thus the reader can see that invention provides a means for secure and repeated access to an electronic device, without the limitations of previous smart cards. This is especially useful in a situation like a pharmacy, hospital or factory where you may have a plurality of users accessing one or more electronic devices throughout a work shift. Throughout the shift the users will have instant, secure access and no loss of tracking data about whom performed which tasks. While the above description contains many specifications, these should not be construed as limitations on the scope of the invention, but rather as an exemplification of one preferred embodiment thereof. Many other variations are possible. For example, the device need not clasp around the wrist, but may clasp around a finger, neck, buttonhole, etc. Furthermore, the device being accessed by the clasping fob has been described as a ‘electronic device’ but could be anything from a complex network of computers, where the user has access to any or all of them, to a single simple electronic device being accessed by many users. It could also include doors, telephones, cellular phones, personal digital assistants, automated teller machines, cash registers, electronically locking devices, other fobs etc. Also, the interlock in the fob could take on a variety of forms including but not limited to electrical, mechanical or photonic designs. Thus the scope of the invention should be determined by the appended claims and their legal equivalents, rather than by the examples given.

What is claimed is:

1. A device for accessing or activating an electronic interface, comprising:
an electronic fob capable of sending, receiving and storing data, and executing digital instructions,
a way to clasp the fob onto your person, such that removing it from your person requires unclasping,
an interconnect which causes the fob memory to be reset when the clasp is opened.

2. A method of accessing, activating, bringing up the user predefined settings, and or recording of the identity of a user for any electronic device or computing device that is used by one or more users, comprising the following steps:
a user clasps a clasping fob from claim 1 onto their person,
said user approaches said electronic device which detects said clasping fob and the fact that the fob has clear memory,
the electronic device prompts the user for manual input of authentication and or identification data,
upon manually entering said authentication and or identification data into the electronic device, the authentication and or identification data is verified by the electronic device, then transmitted to the clasping fob and saved in the memory,
if the user leaves the proximity of the electronic device, the electronic device detects this and logs the user out,
if the user returns to the proximity of the electronic device, the electronic device detects this and also receives the authentication and or identification data from the fob, which allows the user to use the electronic device without manually entering any authentication and or identification data,
the above two steps can be performed indefinitely until the fob has been unclasped.

3. A system for automating the accessing, activating, bringing up the user predefined settings, and or recording of the identity of a user for any electronic device or computing device that is used by one or more users comprising of:
a fob described in claim 1,
an electronic interface that communicates wirelessly to the fob, senses the proximity of said fob to said electronic device, and passes on the information to and from the electronic device,
a display which is part of the electronic device or is operatively connected to the electronic device to be accessed that prompts the user to enter the password, display successful or unsuccessful login,
a memory controller that stores user information
whereby the user is prompted on said display to enter a password if the information passed on from said electronic interface indicates that the user is wearing the fob that has a clear memory and
whereby the password is checked for validity and if valid the password is sent to the electronic interface for transmission and storage in the fob and
whereby the user is automatically allowed access to the electronic device and/or the predefined settings for that user is automatically loaded to the electronic device if the information passed on from the electronic interface indicates that the user is wearing a fob with a valid password.
